(19) United States
(12) Patent Application Publication
(10) Pub. No.: US 2024/0169032 A1
(43) Pub. Date: May 23, 2024

(54) REGIME SHIFT DETECTION

(71) Applicant: Microsoft Technology Licensing, LLC, Redmond, WA (US)

(72) Inventors: Laurent BOUÉ, Petah Tikva (IL); Kiran RAMA, Bangalore (IN); Ravi Prasad KONDAPALLI, Bangalore (IN)

(21) Appl. No.: 18/057,976

(22) Filed: Nov. 22, 2022

(51) Int. Cl. G06F 18/2321; G06F 18/27

(52) U.S. Cl. CPC G06F 18/2321; G06F 18/27

(57) ABSTRACT

The described technology provides detection of a regime shift in streaming data by generating a curve fit of the streaming data representing an attribute over a duration to each of a plurality of probability density functions, scoring conformity of each curve fit to yield a plurality of fit scores, selecting a first duration probability density function among the plurality of probability density functions based on satisfaction of a probability density function fit condition by the fit score corresponding to the first duration probability density function, determining a probability density function change between the selected first duration probability density function and a second duration probability density function, wherein the second duration probability density function is selected for streaming data representing the attribute over a different duration, and indicating detection of the regime shift based on the determined probability density function change satisfying a shift condition.

### BACKGROUND

Inferential models are trained to ingest input data and to output inferences based on the input data. Circumstances can cause the output inferences generated by the model to undergo a regime shift over time. The regime shift results from a change in the circumstances under which the data is collected or other circumstances that cause the model to output invalid inferences from the input data. The regime shift is often characterized as data drift or model drift.

### SUMMARY

The described technology provides detection of a regime shift in streaming data by generating a curve fit of the streaming data representing an attribute over a duration to each of a plurality of probability density functions, scoring conformity of each curve fit to yield a plurality of fit scores, selecting a first duration probability density function among the plurality of probability density functions based on satisfaction of a probability density function fit condition by the fit score corresponding to the first duration probability density function, determining a probability density function change between the selected first duration probability density function and a second duration probability density function, wherein the second duration probability density function is selected for streaming data representing the attribute over a different duration, and indicating detection of the regime shift based on the determined probability density function change satisfying a shift condition.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system 100 for detecting a regime shift in streaming data.

FIG. 2 illustrates another example system 200 for detecting a regime shift in streaming data.

FIG. 3 illustrates example operations 300 for detecting a regime shift in streaming data.

FIG. 4 illustrates an example computing device 400 for implementing the features and operations of the described technology.

### DETAILED DESCRIPTIONS

Model drift detection can be difficult in settings where streaming data is introduced to an inferential model (e.g., a machine learning model) in real-time. It is often impractical to provide ground truth labels for output inferences in real time. Data labeling often requires extensive human intervention to confirm that the output of the inferential model is valid. Because ground truth data is not available in real time, model drift can go undetected. Real-time model drift detection methods rely on central tendency measures. Examples of central tendency measures include averages, standard deviations, skewnesses, kurtosises, Kullback-Leibler divergences, or principal component analyses. The central tendency measures are often ineffective in detecting a regime shift, particularly for streaming data that cannot be calibrated with ground truth labels in real time. Central tendency measures do not independently identify changes in the data generation process (e.g., in the absence of ground truth labels) and are unable to isolate the time at which the drift occurred. Also, tracking central tendency measures for Internet of Things (IoT) devices can be too compute-intensive for edge devices and/or can cause bottlenecks in networks with limited bandwidth.

In at least one implementation, the presently described technology determines drift in the inferential model by comparing probability density functions (PDFs) applied to streaming data at different times. For example, if first streaming data representing an attribute over a first duration (e.g., period of time or number of samples) conforms (e.g., satisfies a probability density function fit condition) differently to PDFs relative to second streaming data representing the attribute over a second duration (e.g., a duration prior to the first duration), a regime shift detector determines that a regime shift in the streaming data has occurred. The different conformity can include that the first streaming data and second streaming data conform well to different types of PDF or that the curve fits of each of the first streaming data and second streaming data to a type of PDF have significantly different parameters.

While often described with respect to a single attribute, the shift can be assessed with respect to multiple attributes. For example, the regime shift detector is configured to detect the regime shift based on a determined PDF change satisfying a shift condition. The shift condition can be based on PDF changes detected for one or more attributes.

In implementations, if the regime shift detector detects a regime shift that satisfies the shift condition, the regime shift detector restricts access to the inferential model. For example, the regime shift detector can instruct a computing device to remove selectable references to the inferential model or can transfer the inferential model to an area inaccessible to the computing device.

In implementations, generating a curve fit between the streaming data and the PDFs can include fitting to multiple component PDFs that together form the selected PDF. For example, the streaming data may include a first portion that conforms best to a first component PDF and a second portion that conforms best to a second PDF. In implementations, the streaming data may be normalized to provide relative context for different attributes. An implementation of the normalization includes combining attributes with related dimensionalities to yield a combined attribute that is dimensionless. Various such implementations may be combined to include evaluations of different PDFs and/or different parameters.

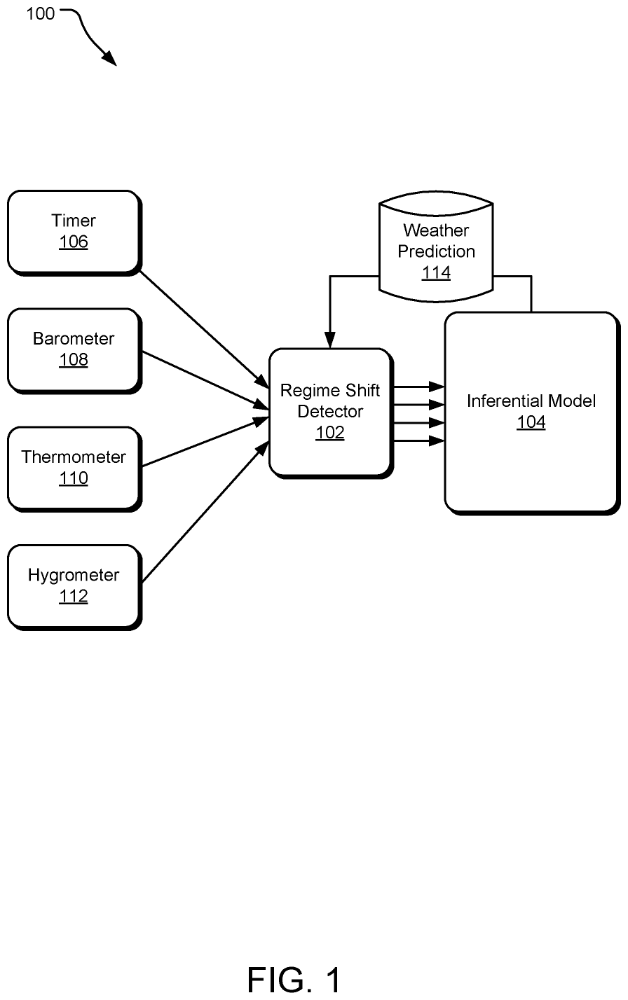

FIG. 1 illustrates an example system 100 for detecting a regime shift in streaming data. In the illustrated implementation, the system 100 determines whether there is a regime shift in a system for predicting the weather. A regime shift detector 102 evaluates streaming data provided by IoT devices, such as a timer 106, a barometer 108, a thermometer 110, or a hygrometer 112 and/or evaluates an output prediction (e.g., a weather prediction 114) from an inferential model 104 (e.g., a machine learning model). The regime shift detector 102 determines whether a regime shift has occurred in the streaming data or in the inferential model 104 based on the evaluation. If a regime shift has occurred, it indicates that the streaming data or the inferential model 104 has experienced a shift that may render the inferential model 104 ineffective for evaluating the streaming data. In an implementation, the streaming data (e.g., including the weather prediction 114) is processable by the inferential model 104 in that the streaming data is at least partially receivable by the inferential model 104, the streaming data is at least partially output by the inferential model 104, or is otherwise usable by the inferential model 104.

In an implementation, the regime shift detector receives streaming data of attributes, such as timing data (represented as times or discrete samples) from the timer 106, pressure data from the barometer 108, temperature data from the thermometer 110, or humidity data from the hygrometer 112. In an implementation, the regime shift detector 102, additionally or alternatively, receives model output data such as a weather prediction 114 output by the inferential model 104 (which may additionally or alternatively be represented as streaming data over time). For streaming data for each of one or more attributes over a first duration, the regime shift detector 102 generates a curve fit of the streaming data to each of a plurality of PDFs. Generating the curve fit may include generating fit parameters for the curve fits (e.g., parameters of the relevant PDFs that conform the curve fit to the relevant PDFs). In an implementation, the curve fits are generated for each combination of attributes considered over the first duration and each type of PDF of the plurality of PDFs considered.

Examples of PDF types include a Gaussian (normal) distribution, a log-normal distribution, a Pareto distribution, a discrete uniform distribution, a continuous uniform distribution, a Bernoulli distribution, a binomial distribution, a negative binomial distribution, a geometric distribution, a hypergeometric distribution, a beta-binomial distribution, a categorical distribution, a multinomial distribution, a multivariate hypergeometric distribution, a Poisson distribution, an exponential distribution, a gamma distribution, a Rayleigh distribution, a Rice distribution, a chi-squared distribution, a student's t distribution, an f-distribution, a beta distribution, a Dirichlet distribution, or a Wishart distribution. Each of the distributions may include one or more fit parameters to better conform the models to the streaming data.

The regime shift detector 102 scores conformity of each curve fit to yield a plurality of fit scores. The fit scores can include any metric used to determine a fit of a curve, including, for example, a residual sum of squares (RSS). The fit scores are determined for each combination of attributes considered over the first duration and each type of PDF of the plurality of PDFs considered.

The regime shift detector 102 selects a first duration PDF for each of one or more attributes considered based on the first duration PDF satisfying a PDF fit condition for the corresponding attribute. A PDF fit condition can include a threshold fit score, a range of acceptable fit scores, or a comparison between determined fit scores (e.g., the selected first duration PDF has the highest, lowest, or otherwise best-fit score of the PDFs considered).

The regime shift detector 102 determines a PDF change between the selected first duration PDF for each of the one or more attributes and a second duration PDF for each of the one or more attributes. The second duration PDF is selected for streaming data of each attribute over a second duration (e.g., prior to the first duration). In implementations, the regime shift detector 102 selects the second duration PDF similarly to how the regime shift detector 102 selects the first duration PDF, but for streaming data from the second duration. In implementations, the first duration and the second duration are different but overlapping or are different and non-overlapping.

In an implementation, the regime shift detector 102 then determines whether the determined PDF change satisfies a shift condition to determine whether a regime shift has occurred. In implementations, the shift condition can depend on the type of PDF change detected. For example, if the PDF change detected includes that the type of PDF of the first duration PDF and the second duration PDF differs, the shift condition includes that the type of PDF has changed in a manner that suggests a regime change. For example, if the types of PDF are relatively similar, the regime shift detector may or may not automatically determine that a regime shift has occurred. If the PDF change detected includes that the first duration PDF and the second duration PDf are of the same PDF type but have different attribute fit parameters (e.g., curve fit parameters), the shift condition can include a threshold or acceptable range of differences between one or more of the attribute fit parameters.

In implementations, the regime shift detector 102 determines PDF changes for a number of different attributes, and the shift condition considers the PDF changes for the different attributes. For example, the regime shift detector 102 can determine a weighted shift score based on relative weights assigned to each attribute or PDF change and/or scores assigned to types of PDf changes. For example, if the first duration PDF for a first attribute is of a Gaussian type, and a second duration PDF of the first attribute is of a Poisson type, the regime shift detector 102 assigns a shift score of 2 for that attribute. In another example, if the first duration PDF and the second duration PDF for a second attribute are both of a Gaussian type, but the first duration PDF and second duration PDFs have mean attribute fit parameters of 1 and 1.2 and variance attribute fit parameters of 0.3 and 0.5, respectively, the regime shift detector 102 assigns a shift score of 0.7 for that attribute based on a predefined relationship between the attribute fit parameters and shift score. If the first duration attribute has a weight of 1, and the second duration attribute has a weight of 6, the shift score is 6.2 (e.g., 2×1+6×0.7=6.2). In this example, the shift condition is that the shift score is less than 6. Because the determined shift score of 6.2 exceeds the shift condition score of 6, the regime shift detector 102 detects that there has been a regime shift.

In response to detecting a regime shift, the regime shift detector 102 indicates the detection of the regime shift. Examples of a regime shift detection indication include transmission of an indication to a computing system that the regime shift occurred, an instruction restricting access to the streaming data, an instruction restricting access to the inferential model 104, an indication that the inferential model 104 should be retrained, an instruction to retrain the inferential model 104 (e.g., based on data in the first duration), an indication of the attributes for which the PDFs have changed, or an indication of the elements of the PDFs that have changed for one or more of the attributes.

As used herein, implementations of the inferential model 104 include, without limitation, one or more of data mining algorithms, artificial intelligence algorithms, masked learning models, natural language processing models, neural networks, artificial neural networks, perceptrons, feed-forward networks, radial basis neural networks, deep feed-forward neural networks, recurrent neural networks, long/short term memory networks, gated recurrent neural networks, autoencoders, variational autoencoders, denoising autoencoders, sparse autoencoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, Kohonen networks, support vector machines, federated learning models, and neural Turing machines. In implementations, a model trainer trains and validates the inferential model 104 by an inference model training method. As used herein, implementations of training methods for training the inferential model 104 (e.g., inferential and/or machine learning methods) include, without limitation, one or more of masked learning modeling, unsupervised learning, supervised learning, reinforcement learning, self-learning, feature learning, sparse dictionary learning, anomaly detection, robot learning, association rule learning, manifold learning, dimensionality reduction, bidirectional transformation, unidirectional transformation, gradient descent, autoregression, autoencoding, variational autoencoding, permutation language modeling, two-stream self attenuation, federated learning, absorbing transformer-XL, natural language processing (NLP), bidirectional encoder representations from transformers (BERT) models, and variants thereof.

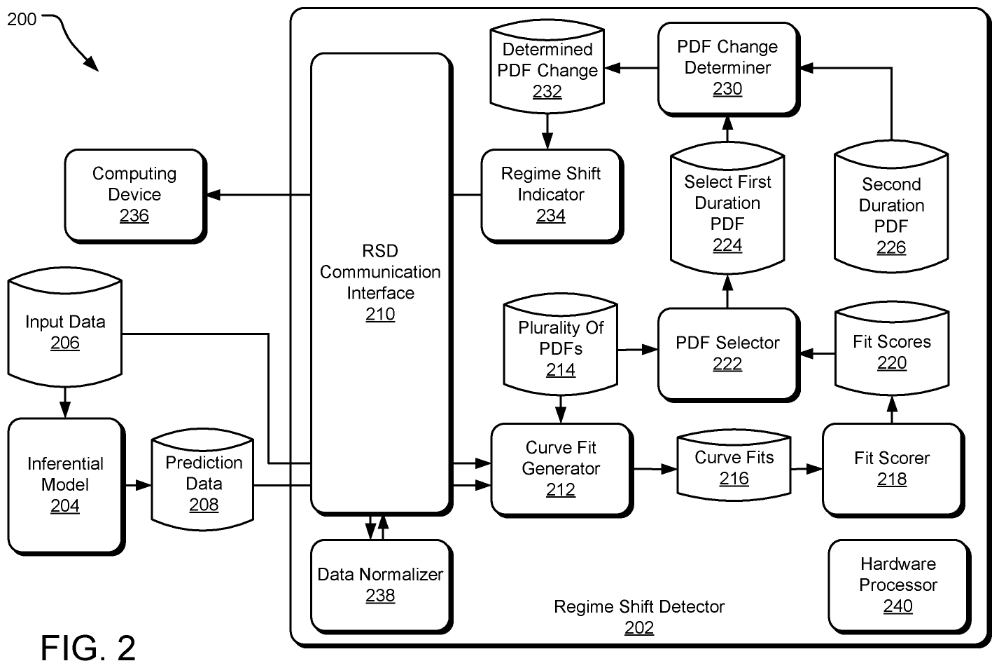

FIG. 2 illustrates another example system 200 for detecting a regime shift in streaming data. The system 200 includes a regime shift detector 202 configured to detect a regime shift. In implementations, the regime shift detector 202 includes one or more of a curve fit generator 212, a fit scorer 218, a PDF selector 222, a PDF change determiner 230, a regime shift indicator 234, a regime shift detector (RSD) communication interface 210, a data normalizer 238, or a hardware processor 240. The regime shift detector 202 may provide indications of a regime shift to a computing device 236.

In the illustrated implementation, the system 200 provides input data 206 (e.g., from IoT devices) to the curve fit generator 212 using the RSD communication interface 210. The system 200, additionally or alternatively, provides the input data 206 to an inferential model 204, which outputs prediction data 208 (which can also be streaming data). The system 200 provides the prediction data 208 outputted from the inferential model 204 to the curve fit generator 212 using the RSD communication interface 210. The input data 206 and the prediction data 208 are collectively referred to as the streaming data.

The streaming data can be represented as a set of data streams that each represent an attribute of the streaming data. Returning to the example of FIG. 1, examples of attributes include time, temperature, pressure, and humidity. The prediction data 208 can also be represented as a streaming attribute in line with the attributes of the streaming data. The streams of data can be represented by X={Xₜ₌₁, . . . , Xₜ₌ₙ, . . . } where X represents the attribute data streams of the streaming data (e.g., of the input data 206 and/or the prediction data 208) considered at each t time or sample. Each timestamp or sample number can be represented by a set of p attributes as X=Xₜ={aₜ¹, . . . , aₜ^{p}}. Each attribute can have its own dimension (e.g., [length], [mass], or [time]).

In implementations, the data normalizer 238 normalizes the streaming data before introduction to the curve fit generator 212. In an implementation, the parameters can be normalized by reducing the dimensionality of the attributes. If there are p attributes and those attributed involve m dimensions, a reparameterized representation k can be represented as k=p−m. The p attributes can be represented independently as p substreams (indexed by i) such that,

Xₜⁱ⁼¹={a₁¹,a₂¹, . . . ,aₜ¹}; Xₜⁱ⁼²={a₁²,a₂², . . . ,aₜ²}; . . . Xₜ^{i=p}={a₁^{p},a₂^{p}, . . . ,aₜ^{p}}

Normalizing can include reducing the number of attributes from p to k.

In this implementation, the values for bₜⁱ are constructed as ratios, products, or more complicated expressions combining the original p raw attributes (that previously had redundant dimensionality). Combining some of the raw attributes can render dimensionless combined attributes. For example, if a₁ and a₂ are both uncombined attributes that represent a related [distance] dimension, b is a dimensionless combined attribute represented by

$$b = \frac{{a}_{1}}{{a}_{2}} .$$

The curve fit generator 212 fits one or more attributes of the streaming data each to a plurality of PDFs 214. The plurality of PDFs can be denoted as F={f₁, . . . , fₘ}. Each of the PDFs can be characterized by q parameters and denoted as fⱼ=fⱼ(Θ₁, . . . , Θ_{q}}. For example, a Gaussian distribution has q=2 parameters (mean and variance), and an exponential distribution has q=1 parameter. The curve fit generator 212 generates curve fits 216 for each of the one or more attributes over the duration to each of the plurality of PDFs 214. For each attribute i (whether normalized or raw) over a duration t, represented as bₜⁱ (reduced dimensionality) or at (original dimensionality), the curve fit generator 212 fits attribute fit parameters Θ for each PDF fⱼ. If fⱼ is a good model for a specific attribute or combined attribute substream, Xₜⁱ={bₜ₊₁ⁱ, bₜ₊₂ⁱ, . . . b_{t+N}ⁱ}, then the observed frequency yₜⁱ of a bₜⁱ or can be closely approximated by yₜⁱ=fⱼ(bₜⁱ).

A fit scorer 218 scores each of the curve fits 216 to determine a fit score 220 of each combination of attribute and PDF. An example of a fit score can include or be based on a residual sum of squares (RSS). For example, the residual sum of squares can be represented as RSSₜ^{i,j}=Σ(yₜ₊ₖⁱ)−fⱼ(bₜ₊ₖⁱ), {k, 1, N}, where yₖⁱ is the observed frequency of the sample aₖⁱ, which may be obtained empirically (e.g., via a fine-grained normalized histogram of Xₜⁱ). This test may be repeated for each attribute or reduced dimension attribute data stream to determine fit scores for each PDF-attribute combination. Other examples of tests or methods the fit scorer 218 can use to determine a fit score 220 include the Bayesian information criterion, the Kolmogorov-Smirnoff test, the Cramér-von Mises criterion, the Anderson-Darling test, the Shapiro-Wilk test, the Chi-squared test, the Akaike information criterion, the Hosmer-Lemeshow test, the Kuiper's test, the Kernelized Stein discrepancy, Zhang's tests, the Moran test, the Density Based Empirical Likelihood Ratio tests, the coefficient of determination, the lack-of-fit sum of squares, the reduced chi-square, a regression validation, Mallows's Cp criterion, the Pearson's chi-square test, the binomial case, or the G-test.

In an implementation, if the fit scores 220 fail to achieve a threshold score (e.g, PDFs considered for an attribute have RSS values that are too high), the curve fit generator 212 may further assess whether the attribute better conforms to a composite PDF with multiple component PDFs. For example, a composite PDF can include two or more component PDFs separated by separation points b*ᵢ. For example fⱼ(bᵢ) denotes a first portion of the attribute data and fₖ(bᵢ) denotes a second portion of the attribute data. Including multiple PDFs implies that there may be more than a single data-generation process combined together in order to produce the data samples. The separation point b*ᵢ can be defined as where both PDFs become equal to each other fⱼ(bᵢ)˜fₖ(bᵢ). This cross-over/separation scale can be interpreted as a typical scale at which the dominating data-generation process switches from a mechanism j to another mechanism k. For example, in fraud detection in expense reports, an objective is to determine the value of b*ᵢ at which “suspicious” behavior starts to manifest itself. The cross-over scale b*ᵢ as defined by the order of magnitude equivalence, allows the separation of data samples in different portions around each b*ᵢ and provides an inference that the data-generation mechanism is “normal” on one side of b*ᵢ and “suspicious” on the other side. In implementations, the order of magnitude equivalence between PDFs, as defined above, provides an inference of the range over which different data-generation processes are dominating. This definition of the separation scale may be independent of the actual value or empirical quantiles of the separation scale. Rather the definition can be based on detecting a change in the underlying behavior of the data generation process.

The PDF selector 222 receives the fit scores 220 and selects a PDF for each attribute (e.g., for each attribute's streaming data over a first duration) based on the fit scores 220. For example, the PDF selector selects a select (or selected) first duration PDF 224 for an attribute based on the fit score of the first duration PDF 224 satisfying a PDF fit condition. A PDF fit condition can include a threshold fit score, a range of acceptable fit scores, or a comparison between determined fit scores (e.g., the selected first duration PDF has the highest, lowest, or otherwise best fit score of the PDFs considered, so it satisfies the fit condition). In the example of a fit score including a residual sum of squares, the fit condition may include determining the PDF with the lowest RSS value for each attribute. The curve fit generator 212, the fit scorer 218, and the PDF selector 222 can repeat this procedure for each attribute for the streaming data over different durations (e.g., measured by time or samples). For example, a second duration may represent time or samples from 0 to t, and a first duration may represent time or samples from t to t+N. In this example, the first duration follows the second duration. Implementations are contemplated in which the first and second duration at least partially overlap.

The RSS-based PDF selection of a selected PDF, r, for each attribute, i, for the second duration from 0 to t can be represented as RSSₜ={rₜ¹, rₜ², . . . rₜ^{t}}. The PDF selector can also produce an RSS-based PDF selection for a first duration from t to t+N. The RSS-based PDF selection of a selected PDF, r, for an attribute, i, for the first duration can be represented as RSSₜ+N {r_{t+N}¹, r_{t+N}², . . . , r_{t+N}^{t}}. In an implementation, the RSSₜ+N includes the select (or selected) first duration PDF 224, and the RSSₜ includes a second duration PDF 226.

In an implementation, for each attribute considered, a PDF change determiner 230 determines whether and/or to what extent a determined PDF change 232 has occurred between the RSSₜ+N (including the first duration PDF 224 for an attribute) and the RSSₜ (including the second duration PDF 226 for the attribute). Examples of the determined PDF change 232 include that the type of PDF differs between the select first duration PDF 224 and the second duration PDF 226 or that the select first duration PDF 224 and the second duration PDF are of the same type but have differing attribute fit parameters representing the fits to the same type of PDF.

In an implementation, the time or sample scales for data attributes may differ. For example, the time to transfer data from cache is different from the time to move data from one cluster to another cluster. In an implementation, in order to appropriately compare attributes that operate on different time scales, the PDF change determiner 230 extracts scales for each attribute. After the PDF selector 222 has selected the PDFs for the attributes, the PDF change determiner 230 assesses the attribute fit parameters. For each selected PDF, rₜⁱ, there are attribute fit parameters Θᵢ={Θᵢ¹ . . . Θᵢ^{q}}. In the case where the attribute data representations bᵢ are already dimensionless (e.g., by normalizing using the data normalizer 238), the attribute fit parameters Oi of the PDFs may also be dimensionless. An argument holds where a particular selected PDF fᵢ=gᵢ(bᵢ; Θᵢ), where the parameters Θᵢ are learned to yield the curve fits 216 by the curve fit generator 212, and gᵢ is an expression that depends on the specific fᵢ considered. If the argument is dimensionless, its reference scale is unity (e.g., one). Therefore, there may be two different regimes separated by the order of magnitude equivalence gᵢ(bᵢ; Θᵢ)˜1. Inverting gᵢ gives an expression with numerical values for Θᵢ learned from the data. This defines:

“high”→gᵢ(bᵢ;Θᵢ)>>1

“low”→gᵢ(bᵢ;Θᵢ)<<1

Each dimensionless attribute i defines a scale relationship. For example, consider the exponential distribution for which there is a single attribute fit parameter Θ that functions as the argument and where b is constructed using the Buckingham theorem with p=2 as

$$b = \frac{{a}_{1}}{{a}_{2}} .$$

Then f(b)=e^{-Θb}. The argument is a product Σb˜1 which yield

$$b \sim \frac{1}{Θ} .$$

### Since

$$b = \frac{{a}_{1}}{{a}_{2}} ,$$

the expression can be inverted to find a relationship involving the original dimensions. For example

$$\frac{{a}_{1}}{{a}_{2}} \sim \frac{1}{Θ}$$

which yields

$${a}_{t}^{1} \sim \frac{{a}_{t}^{2}}{Θ} .$$

Different behaviors are expected when

$${a}_{1} ≪ \frac{{a}_{2}}{Θ}$$

(high probability area) or when

$${a}_{1} ≫ \frac{{a}_{2}}{Θ}$$

(area of negligible probability). Scale extraction may be an implementation of the previously described crossover scales but applied to values of the attribute fit parameters rather than values of the PDFs. Scale extraction develops relationships between normalized attributes in combination with the attribute fit parameter values to allow meaningful comparison between attributes. The scale relationships may define different regimes within which some attributes may be considered as negligible or dominant with respect to other attributes.

In an implementation, the regime shift indicator 234 determines whether the determined PDF change 232 satisfies a shift condition. Satisfaction of the shift condition represents that a regime shift has occurred. In implementations, the shift condition can depend on the type of the determined PDF change 232. For example, in an implementation, if the determined PDF change 232 includes that the types of PDF of the first duration PDF and the second duration PDF differ, the shift condition includes that the type of PDF has changed in a manner that suggests a regime change. For example, in an implementation, if the types of PDF are relatively similar, the regime shift indicator 234 may or may not automatically determine that a regime shift has occurred. In an implementation, if the determined PDF change 232 includes that the first duration PDF and the second duration PDF are of the same PDF type but have different attribute fit parameters, the shift condition can include a threshold or acceptable range of differences between one or more of the attribute fit parameters.

In implementations, the regime shift detector 202 determines PDF changes for a number of different attributes, and the regime shift indicator assesses a shift condition that considers the determined PDF change 232 for each of the different attributes. For example, the regime shift indicator 234 can determine a weighted shift score based on relative weights assigned to each attribute or determined PDF change 232 and/or scores assigned to the type of each determined PDF change 232. For example, if the first duration PDF for a first attribute is of a Gaussian type, and a second duration PDF of the first attribute is of a Poisson type, the regime shift indicator 234 assigns a shift score of 2 for that attribute. In another example, if the first duration PDF and the second duration PDF for a second attribute are both of a Gaussian type, but the first duration PDF and second duration PDFs have mean attribute fit parameters of 1 and 1.2 and variance attribute fit parameters of 0.3 and 0.5, respectively, the regime shift indicator 234 assigns a shift score of 0.7 for that attribute based on a predefined relationship between the attribute fit parameters and shift score. If the first duration attribute has a weight of 1, and the second duration attribute has a weight of 6, the regime shift indicator determines the shift score is 6.2 (e.g., 2×1+6×0.7=6.2). In this example, the shift condition is that the shift score is greater than 5. Because the determined shift score of 6.2 exceeds the shift condition score of 5, the regime shift indicator 234 detects that there has been a regime shift.

In response to detecting a regime shift, the regime shift indicator 234 indicates the detection of the regime shift. Examples of a regime shift detection indication include transmitting an indication to a computing device 236 that the regime shift occurred, restricting access to the streaming data, restricting access to the inferential model 204, indicating that the inferential model 204 should be retrained, retraining the inferential model 204 (e.g., based on data in the first duration), indicating the attributes for which the PDFs have changed (e.g., to the computing device 236), or indicating the elements of the PDFs that have changed for one or more of the attributes.

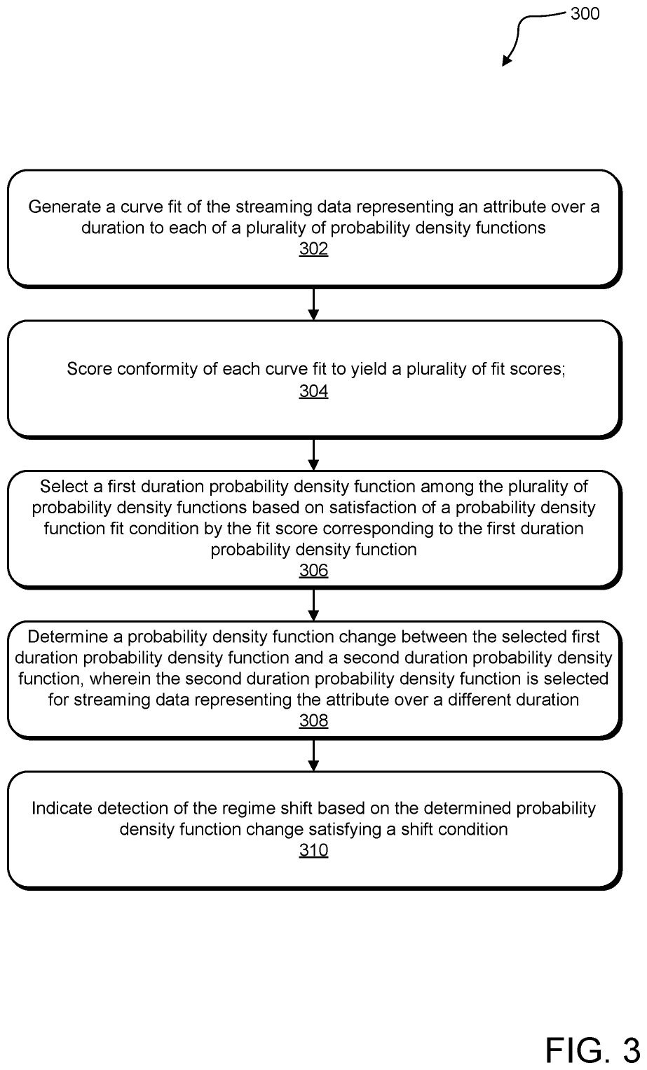

FIG. 3 illustrates example operations 300 for detecting a regime shift in streaming data. The system provides streaming data output from an inferential model to the curve fit generator. The streaming data can be represented as a set of data streams that each represent an attribute of the streaming data. In implementations, a data normalizer normalizes the streaming data and/or the prediction data before introduction to a curve fit generator.

A generating operation 302 generates a curve fit of streaming data representing an attribute over a duration to each of a plurality of probability density functions. The generating operation 302 uses a curve fit generator to fit one or more attributes of the streaming data and/or the prediction data each to a plurality of PDFs, as described herein.

In an implementation, if the fit scores fail to achieve a threshold score (e.g., PDFs for an attribute have RSS values that are too high), the curve fit generator further assesses whether the attribute better conforms to a composite PDF with multiple component PDFs. For example, a composite PDF can include two or more component PDFs separated by separation points b*ᵢ, as described herein.

A scoring operation 304 scores the conformity of each curve fit to yield a plurality of fit scores. The scoring operation 304 uses a fit scorer to score each curve fit to determine a fit score of each combination of attribute and PDF. An example of a fit score can include or be based on a residual sum of squares (RSS). This test may be repeated for each attribute or reduced dimension attribute data stream to determine fit scores for each PDf-attribute combination. Other examples of tests or methods the fit scorer 218 can use are described herein.

A selecting operation 306 selects a first duration probability density function among the plurality of probability density functions based on satisfaction of a probability density function fit condition by the fit score corresponding to the first duration probability density function. The selecting operation 306 uses a PDF selector to select a PDF for each attribute (e.g., for each attribute's streaming data over a first duration) based on the fit scores, as described herein. For example, the PDF selector selects a select (or selected) first duration PDF for an attribute based on the fit score of the first duration PDF satisfying a PDF fit condition. A PDF fit condition can include a threshold fit score, a range of acceptable fit scores, or a comparison between determined fit scores (e.g., the selected first duration PDF has the highest or lowest fit score of the PDFs considered, so it satisfies the fit condition). In the example of a fit score including a residual sum of squares, the fit condition may include determining the PDF with the lowest RSS value for each attribute.

The generating operation 302, the scoring operation 304, and/or the selecting operation can be repeated for each attribute for the streaming data and/or the prediction data over different durations (e.g., measured by time or samples). For example, a second duration may represent time or samples from 0 to t, and a first duration may represent time or samples from t to t+N. In this example, the first duration follows the second duration. Implementations are contemplated in which the first and second duration at least partially overlap. The selecting operation 306 selects the PDF for each attribute based on the fit scores, as described herein.

A determining operation 308 determines a probability density function change between the selected first duration probability density function and a second duration probability density function, wherein the second duration probability density function is selected for streaming data representing the attribute over a different duration. In an implementation, for each attribute considered, the determining operation 308 uses a PDF change determiner to determine whether and/or to what extent a determined PDF change has occurred between the selected PDFs from the first duration (e.g., including a selected first duration PDF) and the selected PDFs from the second duration (e.g., including a second duration PDF). (including the first duration PDF for an attribute) and the RSSₜ (including the second duration PDF for the attribute). Examples of the determined PDF change include that the type of PDF differs between the select first duration PDFs and the second duration PDFs or that the select first duration PDFs and the second duration PDF are of the same type but have differing attribute fit parameters representing the fits to the same type of PDF for each attribute.

In an implementation, the time or sample scales for data attributes may differ. For example, the time to transfer data from cache is different from the time to move data from one cluster to another cluster. In an implementation, in order to appropriately compare attributes that operate on different time scales, the PDF change determiner extracts scales for each attribute, as described herein.

An indicating operation 310 indicates a detection of the regime shift based on the determined probability density function change satisfying a shift condition. In an implementation, the indicating operation uses a regime shift indicator to determine whether the determined PDF change satisfies a shift condition. Satisfaction of the shift condition represents that a regime shift has occurred. In implementations, the shift condition can depend on the type of the determined PDF change. For example, in an implementation, if the determined PDF change includes that the types of PDF of the first duration PDF and the second duration PDF differ, the shift condition includes that the type of PDF has changed in a manner that suggests a regime change. For example, in an implementation, if the types of PDF are relatively similar, the regime shift detector may or may not automatically determine that a regime shift has occurred. In an implementation, if the determined PDF change includes that the first duration PDF and the second duration PDf are of the same PDF type but have different attribute fit parameters, the shift condition can include a threshold or acceptable range of differences between one or more of the attribute fit parameters.

In implementations, the regime shift detector determines PDF changes for a number of different attributes, and the regime shift indicator assesses a shift condition that considers the determined PDF changes for the different attributes, as described herein.

In response to detecting a regime shift, the indicating operation 310 uses the regime shift indicator to indicate the detection of the regime shift. Examples of a regime shift detection indication include transmitting an indication to a computing device that the regime shift occurred, restricting access to the streaming data, restricting access to the inferential model, indicating that the inferential model should be retrained, retraining the inferential model (e.g., based on data in the first duration), indicating the attributes for which the PDFs have changed (e.g., to the computing device), or indicating the elements of the PDFs that have changed for one or more of the attributes.

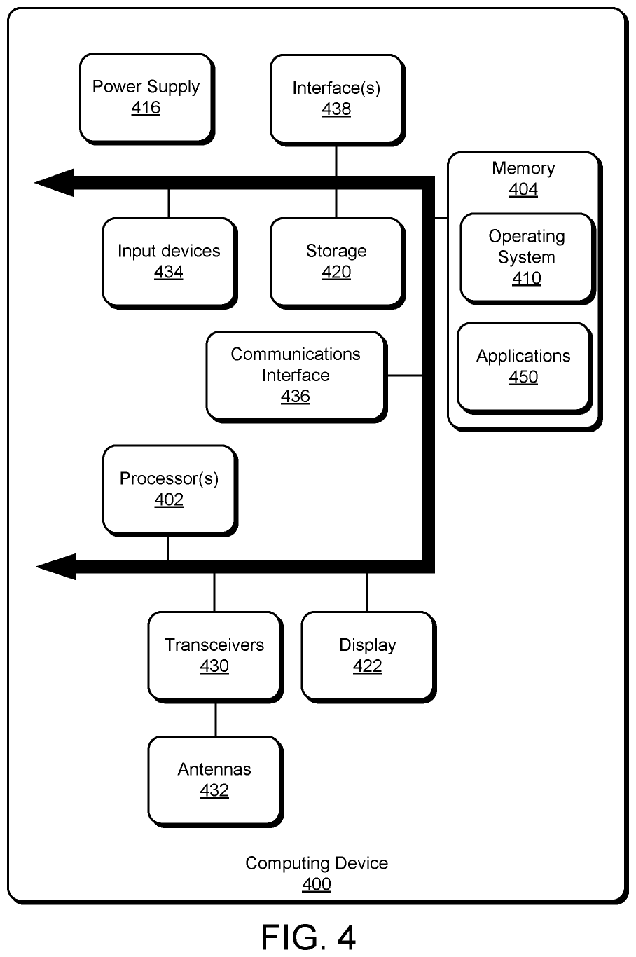

FIG. 4 illustrates an example computing device 400 for implementing the features and operations of the described technology. The computing device 400 may embody a remote-control device or a physically controlled device and is an example network-connected and/or network-capable device or may be a client device, such as a laptop, mobile device, desktop, tablet; a server/cloud device; an internet-of-things device; an electronic accessory; or another electronic device. The computing device 400 includes one or more processor(s) 402 and a memory 404. The memory 404 generally includes both volatile memory (e.g., RAM) and nonvolatile memory (e.g., flash memory). An operating system 410 resides in the memory 404 and is executed by the processor(s) 402.

In an example computing device 400, as shown in FIG. 4, one or more modules or segments, applications 450, inferential models, data normalizers, curve fit generators, fit scorers, PDF selectors, PDF change determiners, regime shift indicators, or regime shift detectors are loaded into the operating system 410 on the memory 404 and/or storage 420 and executed by processor(s) 402. The storage 420 may include one or more tangible storage media devices and may store one or more of streaming data, prediction data, PDFs, curve fits, attribute fit parameters, fit scores, select first duration PDFs, first duration PDFs, second duration PDFs, determined PDF changes, regime shift indications, locally and globally unique identifiers, requests, responses, and other data and be local to the computing device 400 or may be remote and communicatively connected to the computing device 400.

The computing device 400 includes a power supply 416, which is powered by one or more batteries or other power sources and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers and/or client devices (e.g., mobile devices, desktop computers, or laptop computers). The computing device 400 may further include a communications interface 436 (e.g., a network adapter), which is a type of computing device. The computing device 400 may use the communications interface 436 and any other types of computing devices for establishing connections over a wide-area network (WAN) or local-area network (LAN). It should be appreciated that the network connections shown are examples and that other computing devices and means for establishing a communications link between the computing device 400 and other devices may be used.

The computing device 400 may include one or more input devices 434 such that a user may enter commands and information (e.g., a keyboard or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program-specific and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

An example method of detecting a regime shift in streaming data is provided. The method includes generating a curve fit of the streaming data representing an attribute over a duration to each of a plurality of probability density functions; scoring conformity of each curve fit to yield a plurality of fit scores; selecting a first duration probability density function among the plurality of probability density functions based on satisfaction of a probability density function fit condition by the fit score corresponding to the first duration probability density function; determining a probability density function change between the selected first duration probability density function and a second duration probability density function, wherein the second duration probability density function is selected for streaming data representing the attribute over a different duration; and indicating detection of the regime shift based on the determined probability density function change satisfying a shift condition.

Another example method of any preceding method is provided, wherein the second duration probability density function is selected by: generating a different curve fit of the streaming data representing the attribute over the different duration to each of the plurality of probability density functions; scoring conformity of each different curve fit to yield a plurality of different fit scores; and selecting the second duration probability density function among the plurality of probability density functions based on satisfaction of the probability density function fit condition or a different probability density function fit condition by the different fit score corresponding to the second duration probability density function.

Another example method of any preceding method is provided, wherein determining the probability density function change includes determining that the first duration probability density function is of a different type of probability density function from the second duration probability density function.

Another example method of any preceding method is provided, wherein determining the probability density function change includes determining that one or more attribute fit parameters of the first duration probability density function and one or more attribute fit parameters of the second duration probability density function satisfy a fit parameter shift condition.

Another example method of any preceding method is provided, wherein the streaming data representing the attribute over the duration is processable by a machine learning model, and indicating detection of the regime shift includes instructing a computing device to restrict access to a machine learning model based on the indicated regime shift detection.

Another example method of any preceding method is provided, wherein generating a curve fit includes generating at least one curve fit using a first component probability density function and a second component probability density function, wherein the first component probability density function satisfies the probability density function fit condition for a first portion of the streaming data of the attribute over the duration and the second component probability density function satisfies the probability density function fit condition for a second portion of the streaming data of the attribute over the duration, wherein the first duration probability density function includes the first component probability density function and the second component probability density function.

Another example method of any preceding method is provided, further including normalizing uncombined streaming data prior to the operation of fitting by combining dimensionally-related attributes represented in the uncombined streaming data to generate the streaming data of the attribute, the attribute being rendered dimensionless by the combination.

An example system for detecting a regime shift in streaming data is provided. The system includes one or more hardware processors; a curve fit generator executable by the one or more hardware processors and configured to generate a curve fit of the streaming data representing an attribute over a duration to each of a plurality of probability density functions; a fit scorer executable by the one or more hardware processors and configured to score conformity of each curve fit to yield a plurality of fit scores; a probability density function selector executable by the one or more hardware processors and configured to select a first duration probability density function among the plurality of probability density functions based on satisfaction of a probability density function fit condition by the fit score corresponding to the first duration probability density function; a probability density function change determiner executable by the one or more hardware processors and configured to determine a probability density function change between the selected first duration probability density function and a second duration probability density function, wherein the second duration probability density function is selected for streaming data representing the attribute over a different duration; and a regime shift indicator executable by the one or more hardware processors and configured to indicate detection of the regime shift based on the determined probability density function change satisfying a shift condition.

Another example system of any preceding system is provided, wherein the probability density function selector is further configured to generate a different curve fit of the streaming data representing the attribute over the different duration to each of the plurality of probability density functions; score conformity of each different curve fit to yield a plurality of different fit scores; and select the second duration probability density function among the plurality of probability density functions based on satisfaction of the probability density function fit condition or a different probability density function fit condition by the different fit score corresponding to the second duration probability density function.

Another example system of any preceding system is provided, wherein the probability density function change determiner is configured to determine the probability density function change by determining that the first duration probability density function is of a different type of probability density function from the second duration probability density function.

Another example system of any preceding system is provided, wherein the probability density function change determiner is configured to determine the probability density function change by determining that one or more attribute fit parameters of the first duration probability density function and one or more attribute fit parameters of the second duration probability density function satisfy a fit parameter shift condition.

Another example system of any preceding system is provided, wherein the streaming data representing the attribute over the duration is processable by a machine learning model, and the regime shift indicator is configured to indicate detection of the regime shift by instructing a computing device to restrict access to a machine learning model based on the indicated regime shift detection.

Another example system of any preceding system is provided, wherein the curve fit generator is configured to generate the curve fits by generating at least one curve fit using a first component probability density function and a second component probability density function, wherein the first component probability density function satisfies the probability density function fit condition for a first portion of the streaming data of the attribute over the duration and the second component probability density function satisfies the probability density function fit condition for a second portion of the streaming data of the attribute over the duration, wherein the first duration probability density function includes the first component probability density function and the second component probability density function.

Another example system of any preceding system is provided, further including a data normalizer executable by the one or more hardware processors and configured to normalize uncombined streaming data prior to the curve fit generator generating the curve fit, the normalization including combining dimensionally-related attributes represented in the uncombined streaming data to generate the streaming data of the attribute, the attribute being rendered dimensionless by the combination.

One or more example tangible processor-readable storage media embodied with instructions for executing on one or more processors and circuits of a computing device a process of detecting a regime shift in streaming data, the process including generating a curve fit of the streaming data representing an attribute over a duration to each of a plurality of probability density functions; scoring conformity of each curve fit to yield a plurality of fit scores; selecting a first duration probability density function among the plurality of probability density functions based on satisfaction of a probability density function fit condition by the fit score corresponding to the first duration probability density function; determining a probability density function change between the selected first duration probability density function and a second duration probability density function, wherein the second duration probability density function is selected for streaming data representing the attribute over a different duration; and indicating detection of the regime shift based on the determined probability density function change satisfying a shift condition.

One or more other example tangible processor-readable storage media of any preceding media are provided, wherein the second duration probability density function is selected by: generating a different curve fit of the streaming data representing the attribute over the different duration to each of the plurality of probability density functions; scoring conformity of each different curve fit to yield a plurality of different fit scores; and selecting the second duration probability density function among the plurality of probability density functions based on satisfaction of the probability density function fit condition or a different probability density function fit condition by the different fit score corresponding to the second duration probability density function.

One or more other example tangible processor-readable storage media of any preceding media are provided, wherein determining the probability density function change includes determining that the first duration probability density function is of a different type of probability density function from the second duration probability density function.

One or more other example tangible processor-readable storage media of any preceding media are provided, wherein determining the probability density function change includes determining that one or more attribute fit parameters of the first duration probability density function and one or more attribute fit parameters of the second duration probability density function satisfy a fit parameter shift condition.

One or more other example tangible processor-readable storage media of any preceding media are provided, wherein the streaming data representing the attribute over the duration is processable by a machine learning model, and indicating detection of the regime shift includes instructing a computing device to restrict access to a machine learning model based on the indicated regime shift detection.

One or more other example tangible processor-readable storage media of any preceding media are provided, further including normalizing uncombined streaming data prior to the operation of fitting by combining dimensionally-related attributes represented in the uncombined streaming data to generate the streaming data of the attribute, the attribute being rendered dimensionless by the combination.

An example system of detecting a regime shift in streaming data is provided. The system includes means for generating a curve fit of the streaming data representing an attribute over a duration to each of a plurality of probability density functions; means for scoring conformity of each curve fit to yield a plurality of fit scores; selecting a first duration probability density function among the plurality of probability density functions based on satisfaction of a probability density function fit condition by the fit score corresponding to the first duration probability density function; means for determining a probability density function change between the selected first duration probability density function and a second duration probability density function, wherein the second duration probability density function is selected for streaming data representing the attribute over a different duration; and means for indicating detection of the regime shift based on the determined probability density function change satisfying a shift condition.

Another example system of any preceding system is provided, wherein the second duration probability density function is selected using means for generating a different curve fit of the streaming data representing the attribute over the different duration to each of the plurality of probability density functions; means for scoring conformity of each different curve fit to yield a plurality of different fit scores; and means for selecting the second duration probability density function among the plurality of probability density functions based on satisfaction of the probability density function fit condition or a different probability density function fit condition by the different fit score corresponding to the second duration probability density function.

Another example system of any preceding system is provided, wherein the means for determining the probability density function change includes means for determining that the first duration probability density function is of a different type of probability density function from the second duration probability density function.

Another example system of any preceding system is provided, wherein the means for determining the probability density function change includes means for determining that one or more attribute fit parameters of the first duration probability density function and one or more attribute fit parameters of the second duration probability density function satisfy a fit parameter shift condition.

Another example system of any preceding system is provided, wherein the streaming data representing the attribute over the duration is processable by a machine learning model, and the means for indicating detection of the regime shift includes means for instructing a computing device to restrict access to a machine learning model based on the indicated regime shift detection.

Another example system of any preceding system is provided, wherein the means for generating a curve fit include means for generating at least one curve fit using a first component probability density function and a second component probability density function, wherein the first component probability density function satisfies the probability density function fit condition for a first portion of the streaming data of the attribute over the duration and the second component probability density function satisfies the probability density function fit condition for a second portion of the streaming data of the attribute over the duration, wherein the first duration probability density function includes the first component probability density function and the second component probability density function.

Another example system of any preceding system is provided, further including means for normalizing uncombined streaming data prior to the operation of fitting using means for combining dimensionally-related attributes represented in the uncombined streaming data to generate the streaming data of the attribute, the attribute being rendered dimensionless by the combination.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Furthermore, it should be understood that logical operations may be performed in any order, adding or omitting operations as desired, regardless of whether operations are labeled or identified as optional, unless explicitly claimed otherwise or a specific order is inherently necessitated by the claim language. In some cases, the actions recited in the claims can be performed in a different order and still achieve desirable results. In certain circumstances, multitasking and parallel processing may be advantageous. The logical operations making up implementations of the technology described herein may be referred to variously as operations, steps, objects, or modules.

Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

What is claimed is:

1. A method of detecting a regime shift in streaming data, the method comprising:
generating a curve fit of the streaming data representing an attribute over a duration to each of a plurality of probability density functions;
scoring conformity of each curve fit to yield a plurality of fit scores;
selecting a first duration probability density function among the plurality of probability density functions based on satisfaction of a probability density function fit condition by the fit score corresponding to the first duration probability density function;
determining a probability density function change between the selected first duration probability density function and a second duration probability density function, wherein the second duration probability density function is selected for streaming data representing the attribute over a different duration; and
indicating detection of the regime shift based on the determined probability density function change satisfying a shift condition.

2. The method of claim 1, wherein the second duration probability density function is selected by:
generating a different curve fit of the streaming data representing the attribute over the different duration to each of the plurality of probability density functions;
scoring conformity of each different curve fit to yield a plurality of different fit scores; and
selecting the second duration probability density function among the plurality of probability density functions based on satisfaction of the probability density function fit condition or a different probability density function fit condition by the different fit score corresponding to the second duration probability density function.

3. The method of claim 1, wherein determining the probability density function change comprises:
determining that the first duration probability density function is of a different type of probability density function from the second duration probability density function.

4. The method of claim 1, wherein determining the probability density function change comprises:
determining that one or more attribute fit parameters of the first duration probability density function and one or more attribute fit parameters of the second duration probability density function satisfy a fit parameter shift condition.

5. The method of claim 1, wherein the streaming data representing the attribute over the duration is processable by a machine learning model, and indicating detection of the regime shift comprises:
instructing a computing device to restrict access to a machine learning model based on the indicated regime shift detection.

6. The method of claim 1, wherein generating a curve fit comprises:
generating at least one curve fit using a first component probability density function and a second component probability density function, wherein the first component probability density function satisfies the probability density function fit condition for a first portion of the streaming data of the attribute over the duration and the second component probability density function satisfies the probability density function fit condition for a second portion of the streaming data of the attribute over the duration, wherein the first duration probability density function includes the first component probability density function and the second component probability density function.

7. The method of claim 1, further comprising:
normalizing uncombined streaming data prior to the operation of fitting by combining dimensionally-related attributes represented in the uncombined streaming data to generate the streaming data of the attribute, the attribute being rendered dimensionless by the combination.

8. A system for detecting a regime shift in streaming data, the system comprising:
one or more hardware processors;
a curve fit generator executable by the one or more hardware processors and configured to generate a curve fit of the streaming data representing an attribute over a duration to each of a plurality of probability density functions;
a fit scorer executable by the one or more hardware processors and configured to score conformity of each curve fit to yield a plurality of fit scores;
a probability density function selector executable by the one or more hardware processors and configured to select a first duration probability density function among the plurality of probability density functions based on satisfaction of a probability density function fit condition by the fit score corresponding to the first duration probability density function;
a probability density function change determiner executable by the one or more hardware processors and configured to determine a probability density function change between the selected first duration probability density function and a second duration probability density function, wherein the second duration probability density function is selected for streaming data representing the attribute over a different duration; and
a regime shift indicator executable by the one or more hardware processors and configured to indicate detection of the regime shift based on the determined probability density function change satisfying a shift condition.

9. The system of claim 8, wherein the probability density function selector is further configured to:
generate a different curve fit of the streaming data representing the attribute over the different duration to each of the plurality of probability density functions;
score conformity of each different curve fit to yield a plurality of different fit scores; and
select the second duration probability density function among the plurality of probability density functions based on satisfaction of the probability density function fit condition or a different probability density function fit condition by the different fit score corresponding to the second duration probability density function.

10. The system of claim 8, wherein the probability density function change determiner is configured to determine the probability density function change by determining that the first duration probability density function is of a different type of probability density function from the second duration probability density function.

11. The system of claim 8, wherein the probability density function change determiner is configured to determine the probability density function change by determining that one or more attribute fit parameters of the first duration probability density function and one or more attribute fit parameters of the second duration probability density function satisfy a fit parameter shift condition.

12. The system of claim 8, wherein the streaming data representing the attribute over the duration is processable by a machine learning model, and the regime shift indicator is configured to indicate detection of the regime shift by instructing a computing device to restrict access to a machine learning model based on the indicated regime shift detection.

13. The system of claim 8, wherein the curve fit generator is configured to generate the curve fits by generating at least one curve fit using a first component probability density function and a second component probability density function, wherein the first component probability density function satisfies the probability density function fit condition for a first portion of the streaming data of the attribute over the duration and the second component probability density function satisfies the probability density function fit condition for a second portion of the streaming data of the attribute over the duration, wherein the first duration probability density function includes the first component probability density function and the second component probability density function.

14. The system of claim 8, further comprising:
A data normalizer executable by the one or more hardware processors and configured to normalize uncombined streaming data prior to the curve fit generator generating the curve fit, the normalization including combining dimensionally-related attributes represented in the uncombined streaming data to generate the streaming data of the attribute, the attribute being rendered dimensionless by the combination.

15. One or more tangible processor-readable storage media embodied with instructions for executing on one or more processors and circuits of a computing device a process of detecting a regime shift in streaming data, the process comprising:
generating a curve fit of the streaming data representing an attribute over a duration to each of a plurality of probability density functions;
scoring conformity of each curve fit to yield a plurality of fit scores;
selecting a first duration probability density function among the plurality of probability density functions based on satisfaction of a probability density function fit condition by the fit score corresponding to the first duration probability density function;
determining a probability density function change between the selected first duration probability density function and a second duration probability density function, wherein the second duration probability density function is selected for streaming data representing the attribute over a different duration; and
indicating detection of the regime shift based on the determined probability density function change satisfying a shift condition.

16. The one or more tangible processor-readable storage media of claim 15, wherein the second duration probability density function is selected by:
generating a different curve fit of the streaming data representing the attribute over the different duration to each of the plurality of probability density functions;
scoring conformity of each different curve fit to yield a plurality of different fit scores; and
selecting the second duration probability density function among the plurality of probability density functions based on satisfaction of the probability density function fit condition or a different probability density function fit condition by the different fit score corresponding to the second duration probability density function.

17. The one or more tangible processor-readable storage media of claim 15, wherein determining the probability density function change comprises:
determining that the first duration probability density function is of a different type of probability density function from the second duration probability density function.

18. The one or more tangible processor-readable storage media of claim 15, wherein determining the probability density function change comprises:
determining that one or more attribute fit parameters of the first duration probability density function and one or more attribute fit parameters of the second duration probability density function satisfy a fit parameter shift condition.

19. The one or more tangible processor-readable storage media of claim 15, wherein the streaming data representing the attribute over the duration is processable by a machine learning model, and indicating detection of the regime shift comprises:
instructing a computing device to restrict access to a machine learning model based on the indicated regime shift detection.

20. The one or more tangible processor-readable storage media of claim 15, further comprising:
normalizing uncombined streaming data prior to the operation of fitting by combining dimensionally-related attributes represented in the uncombined streaming data to generate the streaming data of the attribute, the attribute being rendered dimensionless by the combination.
